(19) United States
(12) Patent Application Publication
(10) Pub. No.: US 2003/0044483 A1
(43) Pub. Date: Mar. 6, 2003

(54) Compression molding with protective sleeves for preforms

(76) Inventor: James E. Cabak, Plymouth, MN (US)

Correspondence Address: PATENT DEPARTMENT, LARKIN, HOFFMAN, DALY & LINDGREN, LTD., 1500 WELLS FARGO PLAZA, 7900 XERXES AVENUE SOUTH, BLOOMINGTON, MN, 55431, US

(21) Appl. No.: 09/947,805

(22) Filed: Sep. 5, 2001

(51) Int. Cl. B29B 11/14; B29B 15/00

(52) U.S. Cl. 425/449; 264/104; 264/40.4; 264/109; 264/122; 264/125; 264/126; 264/334

(57) ABSTRACT

Protective containers are provided for transporting moldable preform charges used in precision molding operations, in which the moldable material includes a conductive filler in a thermosetting resin matrix. The granular moldable material is loaded into the containers and compacted. Next, the loaded containers are transported to a molding station, where each preform of the moldable material is ejected from its container. The containers are sufficiently rigid to hold their shapes under high compaction pressures, thus to determine preform shapes with greater precision. By surrounding the preforms, the containers minimize evaporative loss of monomer, maintaining the preforms in a condition more suitable for molding, and reducing the impact of monomer loss on the surrounding environment. Each such container can take the form of a sleeve, or may have an end wall incorporating a flexure at one end.

### BACKGROUND OF THE INVENTION

The present invention relates to molding apparatus and processes, and more particularly to the shaping and handling of preforms prior to molding the preforms into their final shapes, typically for use as bipolar plates in fuel cells.

Polymer electrolyte fuel cells are attracting increased attention as an alternative energy source that is relatively clean, with a low potential for harming the environment. A typical fuel cell assembly or unit includes a stack of fuel cells, each cell including a catalyzed proton exchange membrane, an anode on one side of the membrane and a cathode on the other side. Adjacent fuel cells are separated by conductive bipolar plates. Each bipolar plate provides an impermeable barrier between its adjacent cells, and contacts the anode of one cell and cathode of the cell on the opposite side. A flow field, i.e. a complex network of interconnected flow channels, is formed on each side of the plate, to provide to the extent possible an equal flow distribution of reactants and reaction products (in the form of fluids, either liquids or gasses) over the entire area of the adjacent fuel cell membrane. For a further explanation of fuel cell assemblies, references made to U.S. Pat. No. 6,248,467 (Wilson et al.).

Several different materials have been used in forming the bipolar plates to meet the requirements of electrical conductivity, resistance to corrosion, and precisely formed flow channels. One of these is graphite. Machining the graphite to form the flow channels is difficult and costly. Graphite also is so brittle that fabricating thin bipolar plates is impractical. Stainless steel has been used, facilitating fabrication of thinner bipolar plates. However, machining remains expensive, and steel as compared to graphite is more subject to corrosion.

The aforementioned Wilson patent discloses an improved bipolar plate and method for its manufacture. Essentially, graphite or another electrically conductive powder is imbedded in a polymeric matrix, preferably a vinyl ester resin. Other components may be present to varying degrees, e.g. a catalyst, a promoter, an accelerator, an inhibiter to prevent polymerization at room temperature, an antifoam agent, and a fluorochemical intermediate or other release agent. The compound has been found particularly well suited for fabricating bipolar plates for fuel cells, because it facilitates fabrication by molding to eliminate the machining step, and provides a material with sufficient strength to enable fabrication of plates that are relatively thin yet possess the request structural strength.

It is a common practice in molding operations to form certain moldable materials into a disk or “hockey puck” preform to facilitate handling prior to molding. When traditional thermosetting resins and other polymeric materials are used, the intermediate products or preforms are relatively rigid and easy to handle. In contrast, moldable compounds described above and in the aforementioned Wilson patent form intermediate products tending to be wet, sticky and friable.

Such pucks or intermediate products can be transported to a molding station manually with care. However, automated transport or other automated handling is difficult due to the tendency of the intermediate product to fracture under any appreciable griping, or to lose material due to crumbling when products in transport jostle or otherwise contact one another. Further, there is a need to minimize evaporative loss of the monomer constituent of the resin, typically vinyl toluene or styrene. Loss of monomer can result in an intermediate product less suitable for molding. Further, loss of monomer from the intermediate products to the surrounding air creates a potential environmental hazard.

In certain molding processes it is known to provide flexible casings or coverings surrounding thermosetting resins, for their transport to a transfer molding station. For example, see U.S. Pat. No. 5,043,199 (Kubota et al.), and U.S. Pat. No. 5,098,616 (Pas). The molding step itself can be performed with a thermoplastic material surrounded by an elastic ring, as in U.S. Pat. No. 4,229,405 (Coffman), U.S. Pat. No. 3,733,159 (Coffman) and U.S. Pat. No. 4,118,448 (Anderson). Alternatively a rigid ring can surround the material during molding, provided that at some point during the molding step the material is removed from the ring, as taught in U.S. Pat. No. 3,079,642 (Needham).

These approaches, while useful under certain circumstances, fail to satisfy the rigorous requirements for precision in size and shape of the intermediate products, key factors in molding satisfactory bipolar plates. Further, these approaches lack the desired capability to form intermediate products into a variety of different shapes, and to preserve intermediate product shapes during transport to the molding station.

Therefore, it is an object of the present invention to provide a process for forming and transporting compacted friable intermediate moldable products to a molding station with minimal risk of damage, loss of monomer, and loss of solid material.

Another object is to provide a process for shaping friable intermediate moldable products in a manner that affords more consistency in product size and shape.

A further object is to provide a container well adapted for receiving a wet, sticky, granular moldable material, shaping the material into a friable body, and transporting the body to a molding station.

Yet another object is to provide a process and apparatus for forming these moldable materials into intermediate products having a wide variety of predetermined shapes.

### SUMMARY OF THE INVENTION

To achieve these and other objects, there is provided a process for forming an intermediate moldable product and delivering the product to a molding station, including the steps of:

a. providing a granular material including an uncured resin;

b. providing a container with a continuous perimeter wall surrounding an axis, having first and second opposite end regions, and having an inside surface extending between the end regions to define a compartment;

c. loading a portion of the granular material into the compartment through and opening at the first end region of the container;

d. compacting the loaded granular material to form a friable body of the moldable material in the compartment, surrounded by the perimeter wall and having an outside surface contiguous with the inside surface of the perimeter wall;

e. transporting the container, with the friable body contained in the compartment, to a molding station; and

f. removing the friable body from the container at the molding station.

The process is particularly well suited for automated fabrication of bipolar plates. Multiple containers can be loaded in series, then provided to a conveyer for a continuous and serial transport to the molding station. Alternatively, a preforming station can be configured to load and compact several containers simultaneously. Further, several loaded containers can be placed onto a structure and transported to the molding station in a batch mode. In either event the containers protect their associated friable bodies from damage and material loss due to fracture or crumbling. The containers surround their respective intermediate products, thereby minimizing evaporative monomer loss, more effectively maintaining the moldable quality of the intermediate products and enhancing environmental conditions at the fabrication site. Each container further is adapted to assist in forming and shaping the friable body, by accommodating compaction of the loaded granular material.

In a preferred version of the process, the granular material is metered by accumulating material until its weight equals a predetermined threshold, and at that point loading the weighed material into the container. As compared to other forms of metering, e.g. measuring volumes of material or lengths of material output from an extruder, weighing the granular material ensures more consistent, repeatable amounts resulting in more consistently sized and shaped moldable bodies.

According to one approach, the granular material is loaded into the container through an opening at one end. Compaction is achieved by advancing a plunger through the opening to apply pressure to the loaded granular material. The container includes another opening at its opposite end, which facilitates ejection of the friable body from the container through one of the openings by advancing a plunger or other ejector through the other opening.

As an alternative, only one opening is provided, with an end wall opposite from the opening incorporating a flexure. This facilitates ejection of the friable body by applying a force to the flexure to move the friable body axially relative to the container.

Preferably the container is sufficiently rigid such that the perimeter wall retains its shape against radially outward forces due to compaction of the granular material. As a result, the friable body has an outside surface that not only is contiguous with the inside surface of the perimeter wall, but substantially conforms to the inside surface. This provides considerable control over the shape of the friable body, and leads to molded components more consistent as to size and shape.

According to another aspect of the invention, there is provided a device for transporting a friable body of moldable material. The device includes a container having a continuous perimeter wall surrounding an axis. The perimeter wall has first and second opposite end regions and an inside surface extending between the end regions to define a compartment for receiving and containing a metered amount of a granular moldable material loaded into the container. The perimeter wall is adapted to retain its shape against radially outward forces due to compaction of the granular moldable material in the compartment to form a friable body surrounded by the perimeter wall and having an outside surface contiguous with the inside surface of the perimeter wall. The perimeter wall further is adapted to surround the friable body during a transport of the loaded container to a molding station, to substantially prevent damage to the friable body, and loss of monomer and solid material during transport. The inside surface further is shaped to facilitate removal of the friable body from the container at the molding station by moving the friable body axially with respect to the container through an opening at the first end region.

The inside surface of the perimeter wall can extend in the axial direction or alternatively can define a draft angle of at most about five degrees with respect to the axis. In some cases a small undercut may be formed in the container, to more securely hold the friable body. The inside surface can be symmetrical about the axis, e.g. taking the form of a circular cylinder. Alternatively, the inside surface can be rectangular, or given a custom shape intended to facilitate the molding process, e.g. a “dog bone” shape intended for use with a rectangular mold. The perimeter wall advantageously is adapted to retain its shape against the radially outward forces due to compaction of moldable material inside the container, e.g. up to about 500 psi, or preferably up to about 1000 psi.

Thus in accordance with the present invention, compounds uniquely well suited for molding into bipolar plates and other precision components can be employed in automated, high volume processes without damage to friable moldable intermediate products, and without loss of solid material due to fracture or crumbling, or loss of monomer due to evaporation, during transport of the intermediate products to a molding station or other handling of these products. The friable products are formed using weighed amounts of a granular moldable compound or material, thus ensuring greater consistency of size and shape in the intermediate products. Such consistency is further ensured by providing containers sufficiently rigid to maintain the desired shape during high-pressure compaction of granular material previously loaded into the containers. The container inside walls can extend axially, or be inclined to provide draft angles to facilitate ejection of the intermediate product at the molding stage.

### IN THE DRAWINGS

For a further understanding of the above and other features and advantages, reference is made to the detailed description and to the drawings in which:

FIG. 1 is a block diagram illustrating a process for fabricating bipolar plates for fuel cells in accordance with the present invention;

FIG. 2 is an elevational view of a preforming station used in the process to form moldable intermediate products;

FIG. 3 is an enlarged view of a portion of FIG. 2;

FIGS. 4a and 4b show a restricting ring and screen at the preforming station;

FIG. 5 is an elevational view illustrating a sleeve and loader/compactor at the preforming station;

FIG. 6 is a top view illustrating serial conveyance of loaded containers from the preforming station to a molding station, and conveyance of empty containers from the molding station;

FIG. 7 is an elevational view of a pneumatic ejector at the molding station;

FIG. 8 is an elevational view of a mold at the molding station.;

FIGS. 9-11 are cross sectional elevations showing alternative embodiment sleeves;

FIG. 12 is an elevation of an alternative embodiment container used in lieu of a sleeve;

FIG. 13 illustrates the sleeve of FIG. 12 and accompanying ejection mechanism;

FIGS. 14 and 15 illustrate further embodiment containers;

FIG. 16 illustrates an alternative embodiment higher speed preforming station;

FIG. 17 illustrates the automatic conveying of containers toward and away from an alternative embodiment compaction mechanism;

FIG. 18 illustrates an alternative embodiment ejection mechanism and molding press; and

FIG. 19 illustrates an alternative embodiment batch transport structure.

### DETAILED DESCRIPTION OF THE PREFERRED EMBODIMENTS

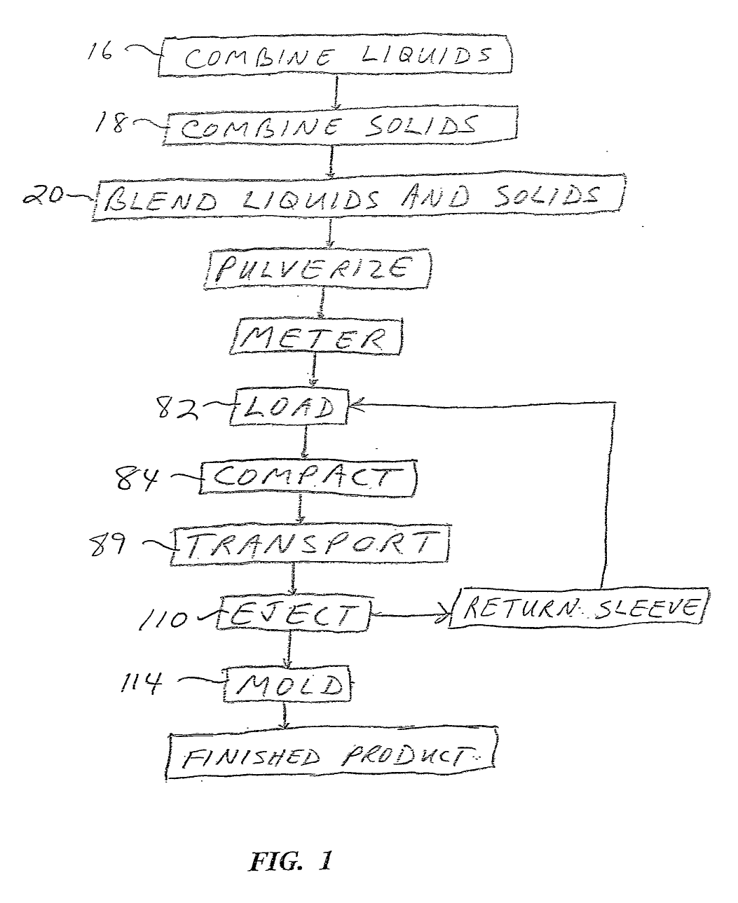

Turning now to the drawings, FIG. 1 is a block diagram illustrating various stages of a process for fabricating bipolar plates for electrolyte fuel cells. Essentially, the bipolar plates consist of a polymeric matrix and an electrically conductive filler. More particularly, the matrix is formed of a thermosetting resin, and the filler typically is graphite.

The initial stages of the process involve combining the constituents, liquids at a stage 16 and solids at a stage 18. The liquid constituents include the resin, preferably a thermosetting resin of the vinyl ester family. A polyester resin also may be used. Components combined with the resin at this stage include a catalyst for curing the resin, promoters or accelerators to speed curing, radical-scavenging inhibitors to prevent curing at room temperature, anti-foam agents, and fluorochemical intermediates or other internal release agents to facilitate separation of the molded bipolar plate from the mold.

The essential solid component at stage 18 is a conductive powder. Further solid components include carbon black and structural fiber for reinforcing the bipolar plate. The preferred conductive powder is graphite, with certain metals, boron carbide and titanium nitrite being suitable alternatives. The carbon black improves the conductivity imparted by a given amount of the conductive powder. The structural fibers can be graphite, glass, or metal.

The liquid output of stage 16 and the solid output of stage 18 are blended at stage 20, resulting in a homogeneous compound with a granular consistency on the order of wet sand, with a sticky or paste-like quality.

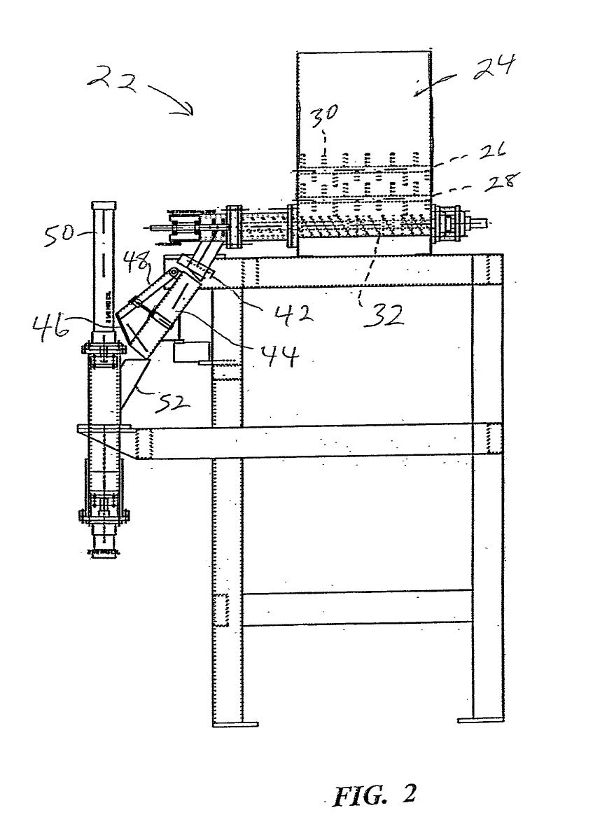

At this point, the compound is ready for preforming, and typically is packaged, then shipped to a customer for preforming and subsequent stages. At a preforming station 22 shown in FIG. 2, the compound is loaded into a hopper 24. Near the bottom of the hopper, shown in phantom lines, are a pair of mixing devices 26, each including a rotatable horizontal (longitudinal) shaft 28 and a series of pins 30 extended transversely from the shaft in different directions. As the compound is moved by gravity past the rotating shafts, the pins break up any larger pieces or chunks, facilitating passage of the material through an opening at the bottom of the hopper. Material leaving the hopper encounters an auger 32, which moves the material leftward as viewed in FIGS. 2 and 3. The mixing devices and the auger are rotated slowly, typically less than about 10 rpm, and more preferably less than about 5 rpm.

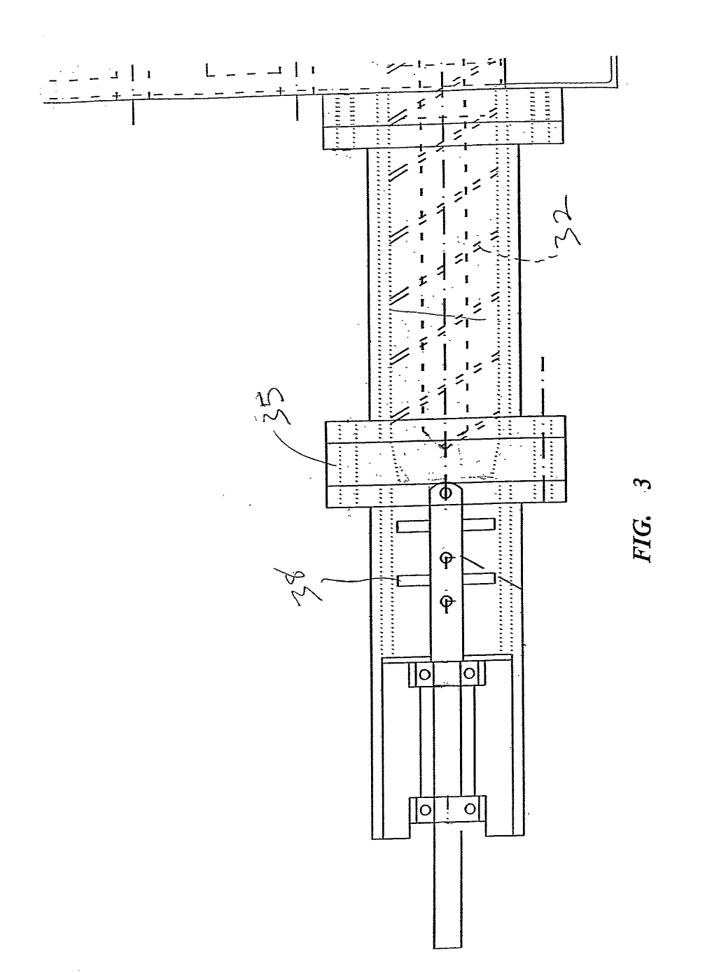

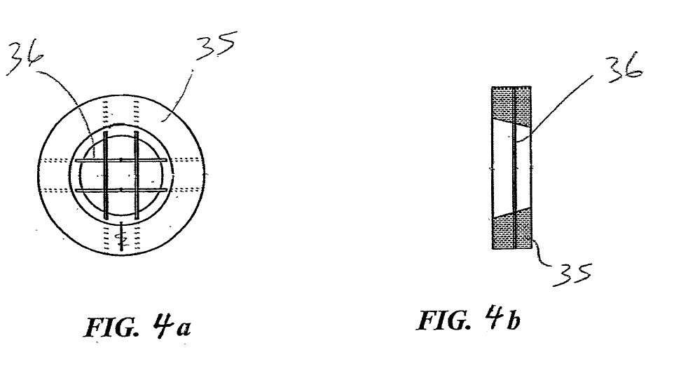

Auger 32 moves the material through a cylinder 34 extending beyond the hopper, then past a restricting ring 35 that supports a screen 36, as seen in FIG. 4. The screen has a mesh size of one-fourth of an inch or more, typically about three-fourths of an inch. The material is forced through the screen to counteract any bunching from the action of the auger. To further ensure a homogeneous blend and maintain the granular consistency, a rotatable mixing device 38 encounters material after its passage through the screen, as best seen in FIG. 3. Then, the further fragmented material enters a chute 40, through an initially open gate 42 into a weigh cell 44.

As seen in FIG. 2, a gate 46 at the lower end of the weigh cell is opened and closed by a pivotable arm 48. Gate 46 initially is closed, allowing compound to accumulate in weigh cell 44 as it passes gate 42. In a manner known to those skilled in the art, accumulation of material to a predetermined net weight triggers a control mechanism which closes gate 42, and simultaneously operates arm 48 to open gate 46 whereby a metered or precisely weighed amount of the material is provided to a loading and compacting mechanism 50.

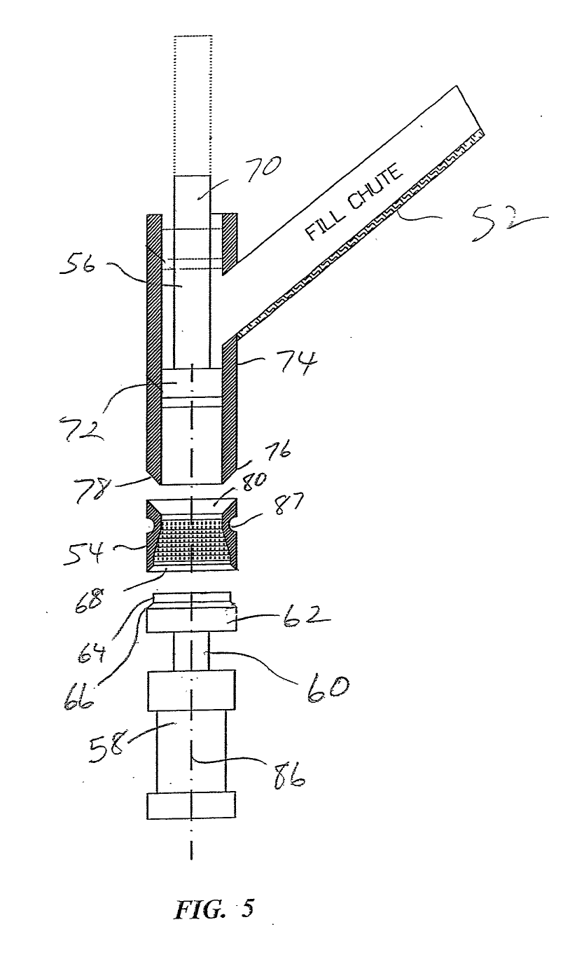

Material is loaded with the aid of a chute 52 that directs the granular, moldable material into a sleeve 54. Sleeve 54 is shown in FIG. 5 in conjunction with chute 52 and the primary components of mechanism 50, namely a hydraulic plunger 56 and a hydraulic lifter 58. As indicated by the arrows, plunger 56 and lifter 58 are vertically reciprocable.

Lifter 58 includes a reciprocating rod 60 and a head 62. A top portion and intermediate beveled portion of head 62 provide respective annular and beveled surfaces 64 and 66 which conform to corresponding surfaces inside sleeve 54 along a bottom end region 68. As a result, the sleeve is removably mountable onto head 62 to form a tight, nesting engagement. When thus engaged with the lifter head, sleeve 54 is adapted to receive and retain a charge of material from the weigh cell.

Plunger 56 includes a rod 70 and a PTFE head 72 that reciprocates within a surrounding cylinder 74. A retracted position of the head and rod is shown in broken lines. A bottom region 76 of the cylinder has a beveled surface 78, corresponding to a beveled surface portion 80 inside the sleeve.

With reference to FIG. 1, a loading stage 82 is followed by a compaction stage 84 in which the granular material is subjected to compaction pressures in the range of 500-1,000 psi, in the absence of any heating so that the resin remains uncured. Compaction begins with an upward extension of lifter 58, until the inside surface of sleeve 54 engages beveled surface 78 of cylinder 74. Then, with lifter 58 maintained, plunger 56 is moved downwardly to bring head 72 into contact with the material. Further downward extension of the plunger creates the desired compaction pressure.

A salient feature of the present invention is the construction of a sleeve or container with sufficient structural integrity to maintain its shape under the compaction pressure. In this respect, sleeve 54 is conveniently viewed as a continuous tubular wall with an inside surface defining a compartment into which the granular moldable material is loaded. When the sleeve is aligned for compaction, the tubular wall surrounds and is centered on a vertical axis 86. An annular groove 87 is used in conjunction with a guide (not shown) to ensure proper centering of the sleeve. Plunger 56 and lifter 58 reciprocate along axis 86, and cooperate to apply axial forces to the granular material in the sleeve. The resulting pressure produces radially outward forces against the inside surface of the sleeve. The sleeve wall has a hoop strength sufficient to maintain its shape in opposition to the radial forces. As a result, compaction forms the granular material into a precisely controlled size and shape, with substantially planar top and bottom surfaces, and an annular outside surface contiguous with and conforming to the inside surface of the sleeve. After compaction, the moldable material no longer has a granular, loose-fill character. Compression creates a body or preform 88 of wet, moldable material having a crumbly or friable character, in which the resin remains uncured.

In laboratory scale operations, this characteristic of the preforms is not a major concern. The bodies can be handled manually, individually, with sufficient care to minimize damage and material loss. By contrast, automated handling raises considerable risk of damage and material loss. For example, jostling and contact among preforms traveling on a conveyor can cause fracture of a preform or cause material to crumble or break away. It would be difficult to robotically grip the friable preform without crumbling or fracturing it. An additional problem is the loss of monomer by evaporation when the preforms are exposed to air. Monomer evaporation causes environmental problems in the vicinity of the preforms, and renders the perform less suitable for molding.

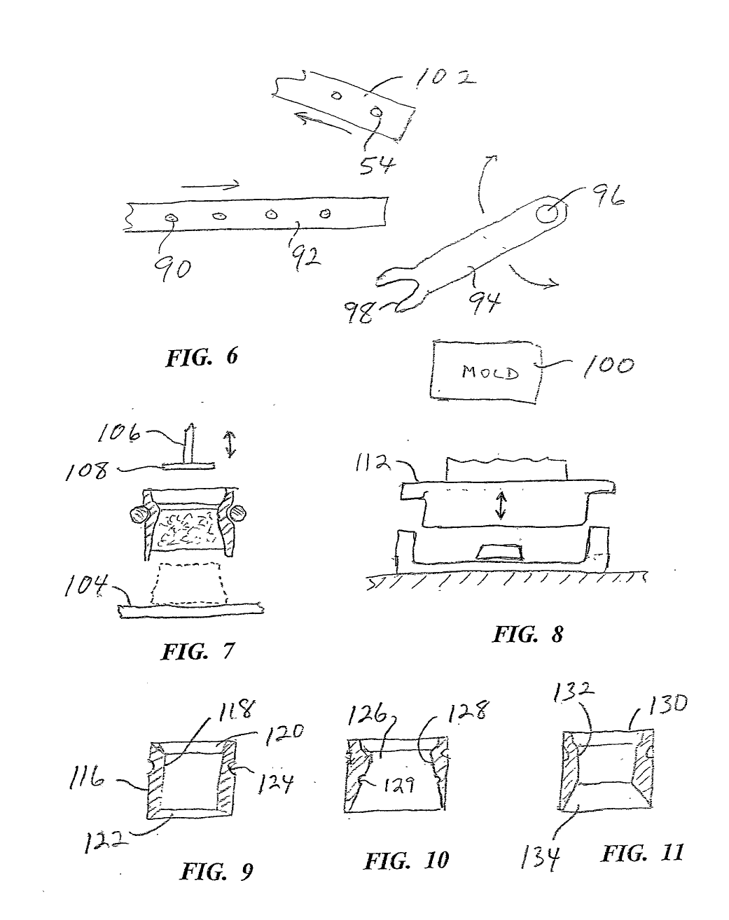

Accordingly, following compaction preform 88 is retained in sleeve 54 during a transport stage 89, i.e. during transfer to a molding station as part of a preform/sleeve combination 90. FIG. 6 shows a conveyor 92 moving in the direction indicated by the arrow, for conveying preform/sleeve combinations 90 continuously and serially toward a robotic arm 94. The robotic arm is mounted to pivot on a shaft 96, to move its gripping end 98 along an arcuate path that includes an end of conveyor 92, a molding station 100, and a conveyor 102 for transporting empty sleeves 54 away from the robotic arm and back to the loading/compacting station for reuse.

In connection with each of the preform/sleeve combinations, robotic arm 94 first is pivoted to extend horizontally as viewed in FIG. 6, positioning gripping end 98 to receive one of the loaded sleeves. Once gripping end 98 engages the sleeve, arm 94 is pivoted counterclockwise as viewed in the figure, to transport the loaded sleeve to molding station 100.

Preform 88 can be deposited directly into a mold cavity at the molding station. With reference to FIG. 7, the preform/sleeve combination is moved by arm 94 directly above the cavity of a mold section 104, and directly below a vertically reciprocable pneumatic plunger 106. Plunger 106 has a head 108 that substantially conforms in diameter to the top surface of the preform. With arm 94 positioning sleeve 54 as shown, plunger 106 is moved in the downward axial direction. After head 108 encounters the top surface of preform 88, its continued movement axially pushes preform 88 relative to sleeve 54, to eject the preform from the sleeve and onto mold section 104, as shown in broken lines. This completes an ejection stage 110.

As an alternative to a direct deposit of the preform onto a mold, the preform can be placed on a transfer plate for subsequent loading onto the mold. Typically, such a transfer plate is slideable horizontally between preform-receiving and preform-depositing locations.

With reference to FIG. 6, after ejection robotic arm 94, still carrying the empty sleeve, is rotated clockwise to the end of conveyor 102 where gripping end 98 is operated to release the empty sleeve. Conveyor 102 serially and continuously transports the empty sleeves back to preforming station 22 for reloading and compaction. Robotic arm 94 is presented as one of several approaches for transferring loaded sleeves from a conveyor to a molding station. Other approaches may be used, for example, guide rails positioned to contact the sleeves at their respective grooves 87.

Meanwhile at molding station 100, an upper mold section 112 is positioned above lower mold section 104 as shown in FIG. 8. Section 112 is brought downward upon section 104, closing the mold and crushing preform 88 to spread the moldable material outwardly (horizontally as viewed in the figure) to substantially fill the mold cavity. At this point section 112 engages section 104 to substantially close the mold. While in the cavity, the material is subjected to elevated pressures, typically in the range of 1,000-4,000 psi. Simultaneously, the material is heated to elevated temperatures to cure the resin, e.g. temperatures in the range of 250-450 degrees F. Molding stage 114 imparts to the material the predetermined shape of the bipolar plate or other final product. Following molding, the product is removed, mold section 112 is withdrawn, and the mold is set to receive another preform.

Sleeve 54 can be plastic or metal, manufactured by machining, thermoforming, or injection molding. Once the material is selected, the primary concern is designing the tubular wall with a thickness sufficient to provide the required rigidity, to counteract radially outward compaction forces as noted above, and preferably also to maintain the sleeve shape in opposition to radially inward forces due to robotic gripping devices or other automated handling equipment.

Sleeves or other containers can be provided in different sizes and shapes to meet different preform requirements. FIG. 9 illustrates a sleeve 116 formed as a circular cylinder, in which an inside surface 118 is centered on a vertical sleeve axis, and parallel to the axis with the exception of bevels at upper and lower end regions 120 and 122. An annular groove 124 can accommodate devices for handling or positioning the sleeve.

FIG. 10 shows a sleeve 126 in which an inside surface 128 is inclined to provide a draft angle with respect to the sleeve axis. Use of a draft angle results in an easier, cleaner ejection of the preform from the sleeve. Surface 128 is inclined at the draft angle over its complete span from one end region of the sleeve to the other. The draft angle is exaggerated in FIG. 10. Typically the draft angle is in the range of 2-5 degrees. In general, it has been found that sleeves such as sleeve 116 are satisfactory for use with preforms up to about 75 grams in weight, with larger preforms requiring sleeves with a draft angle. Anther feature of sleeve 126 is an undercut 129 which is filled with material during compaction, and after compaction holds the preform more securely in the sleeve. When the preform is ejected from the sleeve, it tends to shear at the area of the undercut, leaving the ejected preform with a substantially straight outside wall.

FIG. 11 illustrates a combination sleeve 130 in which an inside surface of the tubular wall has an upper portion 132 parallel to the sleeve axis, and a lower portion 134 determining a draft angle relative to the axis.

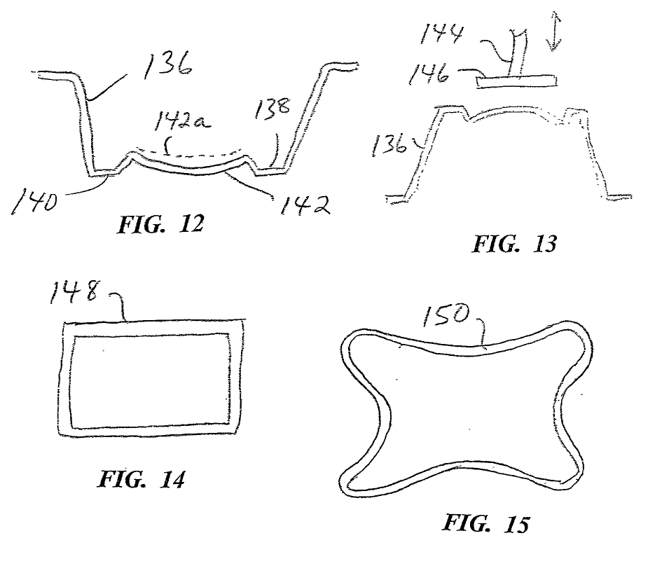

FIGS. 12 and 13 illustrate an alternative embodiment container 136 open at only one end. At the other end, a wall 138 closes the container. End wall 138 incorporates a flexure in the form of a button 140 that can be flexed upwardly as viewed in FIG. 12, to the position indicated by the broken lines at 140a. The container has an inside surface 142 inclined to provide a draft angle.

In FIG. 12, container 136 is shown in position for loading and compaction of granular moldable material. As shown in FIG. 13, the container is inverted in preparation for ejection through use of a pneumatic plunger 144. Downward movement of the plunger brings a head 146 of the plunger into contact with button 140. Further plunger movement causes button 140 to flex downward, thus to eject the preform.

End wall 138 contributes to the strength of the container. Consequently, containers like 136 with end walls can be formed with thinner perimeter walls as compared to similarly sized sleeves, yet provide satisfactory structural strength. The end wall provides a closed bottom for the container to simplify loading. On the other hand, the requirement to invert the loaded container between loading and ejection is a disadvantage compared to the sleeve construction.

FIG. 14 is a top plan view of a further alternative container 148 having a rectangular continuous parameter wall. In FIG. 15, a container 150 has a continuous parameter wall shaped to give the preform a “dog bone” profile. The dog bone shape is advantageous for preforms used to form rectangular bipolar plates, because the dog bone shape promotes the flow of moldable material into the corners of rectangular mold cavities.

Containers 148 and 150 can be formed either as sleeves or with closed ends, and optionally may have inside surfaces inclined to provide draft angles.

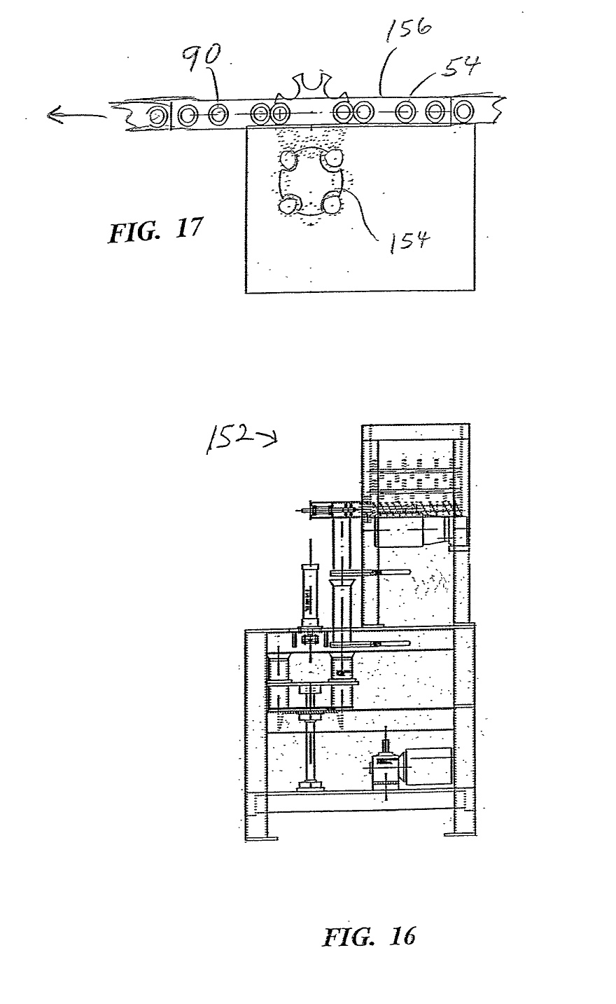

As alternatives to the foregoing process in which preforms are handled continuously and serially, preforms can be loaded, compacted and transported in a batch mode. FIGS. 16-18 illustrate an alternative loading/compaction station 152 in which four sleeves, positioned by a rotary device 154, can be compacted simultaneously, then provided to a conveyor 156 for transport to a molding station.

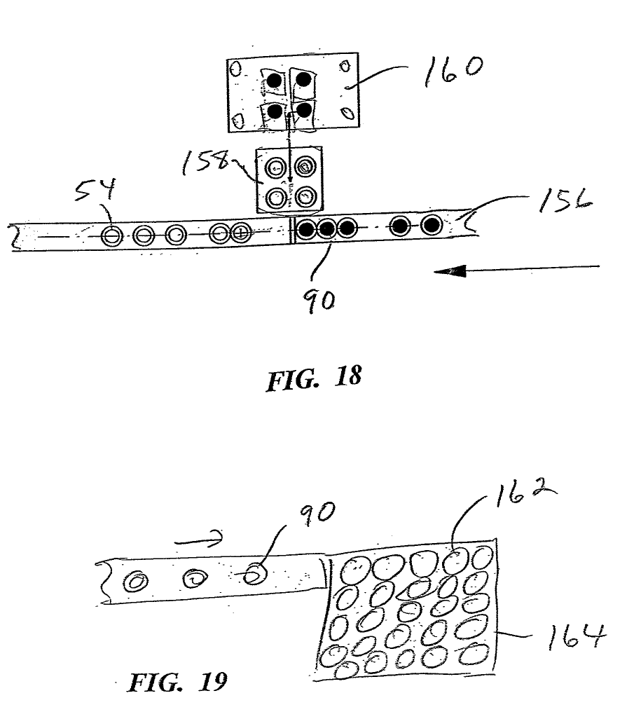

FIG. 18 illustrates an alternative molding station at which loaded sleeves are placed onto a stationary platen 158 in groups of four, then simultaneously ejected with a press platen 160.

FIG. 19 illustrates a batch transport approach in which containers 162, after preform loading and compaction, are moved by a conveyor toward a tray 164 capable of holding multiple containers for a batch transport to one or more molds.

Thus in accordance with the present invention, resin-based compounds for molding bipolar plates for fuel cells and other precision components can be used in high volume, automated fabrication processes. Containers receive the moldable material in granular form, determine precise shapes for the preforms as the material is packed within the containers under high pressure, and protect the preforms against fracture and crumbling when transporting the preforms to a molding stage. The containers may take the form of sleeves, or alternatively may be closed at one end, with the wall at the closed end incorporating a flexure to facilitate ejection of the preform at the molding station. Use of the protective containers in conjunction with metering the granular material on a net weight basis, ensures a high degree of consistency in preform size and shape.

What is claimed is:

1. A device for transporting a friable body of moldable material, including:
a container having a continuous perimeter wall surrounding an axis, the perimeter wall having first and second opposite end regions and an inside surface extending between the end regions to define a compartment for receiving and containing a metered amount of a granular moldable material loaded into the container;
wherein the perimeter wall is adapted to retain its shape against radially outward forces due to compaction of the granular moldable material in the compartment to form a friable body surrounded by the perimeter wall and having an outside surface contiguous with the inside surface of the perimeter wall;
wherein the perimeter wall further is adapted to surround the friable body during a transport of the loaded container to a molding station, to substantially prevent damage to the friable body and material loss during said transport; and
wherein the inside surface further is shaped to facilitate a removal of the friable body from the container at the molding station by moving the friable body axially with respect to the container through an opening at the first end region.

2. The device of claim 1 wherein:
the inside surface of the perimeter wall extends in the axial direction.

3. The device of claim 2 wherein:
planes taken through the end regions of the perimeter wall are substantially perpendicular to the axis.

4. The device of claim 1 wherein:
at least a portion of the inside surface of the perimeter wall defines a draft angle of at most about five degrees with respect to the axis.

5. The device of claim 4 wherein:
the inside surface defines said draft angle over its complete extension between the first and second end regions.

6. The device of claim 1 further including:
an opening at the second end region adapted to admit a pushing device for axially moving the friable body.

7. The device of claim 1 further including:
an end wall mounted with respect to the perimeter wall at the second end region to substantially close the container at the second end region.

8. The device of claim 7 wherein:
the end wall is flexible to accommodate a flexure thereof in the axial direction to so axially move the friable body.

9. The device of claim 1 wherein:
the container is adapted to accommodate a reloading thereof with a subsequent metered amount of the granular moldable material, after the removal of the friable body.

10. The device of claim 1 wherein:
the inside surface of the perimeter wall is symmetrical about the axis.

11. The device of claim 1 wherein:
the perimeter wall is adapted to retain its shape against the radially outward forces due to compaction at pressures up to about 500 psi.

12. The device of claim 11 wherein:
the perimeter wall is adapted to retain its shape against the radially outward forces due to compaction at pressures up to about 1000 psi.

13. A device for shaping a granular moldable material into a friable body prior to a molding operation, including:
a container having a tubular wall surrounding a tube axis, the tubular wall having an inside surface extending between first and second end regions of the tubular wall to define a compartment for receiving and containing a metered amount of a granular moldable material including an uncured resin;
the tubular wall having a hoop strength sufficient to retain its shape in opposition to radially outward forces due to a compaction of the granular moldable material in the compartment, to form the granular moldable material into a friable body surrounded by the tubular wall and having an outside surface substantially conforming to the inside surface of the tubular wall; and
wherein the inside surface of the tubular wall is shaped to facilitate an ejection of the friable body from the container by moving the friable body axially relative to the tubular container through an opening at the first end region.

14. The device of claim 13 wherein:
the tubular wall further is adapted to so surround the friable body during a transporting thereof to a molding station, thereby to substantially prevent damage to the friable body and loss of material during said transport.

15. The device of claim 13 wherein:
the inside surface of the tubular wall extends in the axial direction.

16. The device of claim 15 wherein:
planes containing the first and second end regions are substantially perpendicular to the tube axis.

17. The device of claim 13 wherein:
at least a portion of the inside surface of the tubular wall defines a draft angle with respect to the tube axis.

18. The device of claim 17 wherein:
the inside surface defines the draft angle along its entire span between the first and second end regions.

19. The device of claim 13 further including:
an opening at the second end region adapted to admit an apparatus for pushing the friable body axially relative to the container.

20. The device of claim 13 further including:
an end wall at the second end region substantially closing the container at the second end region.

21. The device of claim 20 wherein:
the end wall incorporates a flexure configured to flex in an axial direction for pushing the friable body axially relative to the container.

22. The device of claim 13 wherein:
the container is adapted for repeated loadings of metered amounts of the granular moldable material, each loading following one of said ejections.

23. The device of claim 13 wherein:
the tubular wall has a hoop strength sufficient to retain its shape in opposition to radially outward forces due to compaction at pressures up to about 500 psi.

24. The device of claim 23 wherein:
the tubular wall has a hoop strength sufficient to retain its shape in opposition to radially outward forces due to compaction at pressures up to about 1000 psi.

25. A process for forming an intermediate moldable product and delivering the product to a molding station, including:
providing a granular material including an uncured resin;
providing a container with a continuous perimeter wall surrounding an axis, having first and second opposite end regions, and having an inside surface extending between the end regions to define a compartment;
loading a portion of the granular material into the compartment through an opening at the first end region of the container;
compacting the loaded granular material to form a friable body of the moldable material in the compartment, surrounded by the perimeter wall and having an outside surface contiguous with the inside surface of the perimeter wall;
transporting the container, with the friable body contained in the compartment, to a molding station; and
removing the friable body from the container at the molding station.

26. The process of claim 25 wherein:
said transporting the container includes providing a conveyor to continuously and serially transport a plurality of the containers and individually associated friable bodies inside the respective compartments.

27. The process of claim 25 wherein:
said transporting the container includes providing a structure for transporting several of the containers and associated friable bodies simultaneously in a batch mode.

28. The process of claim 25 wherein:
said providing the granular material includes providing a mixture including a granular uncured resin and an electrically conductive granular filler.

29. The process of claim 25 wherein:
said loading a metered amount of the granular material includes accumulating the material until a weight of the material equals a predetermined threshold, then loading the accumulated amount into the container.

30. The process of claim 25 wherein:
the granular material is loaded into the compartment through an opening at the first end region of the container, and the compacting comprises advancing a plunger through the first opening to apply a pressure of at least about 500 psi to the loaded granular material.

31. The process of claim 30 wherein:
the plunger is advanced to apply a pressure in the range of 500-1000 psi to the granular material.

32. The process of claim 30 wherein:
the providing of the container includes providing a container in which the continuous perimeter wall is adapted to retain its shape against radially outward forces due to compaction of the granular material, whereby the friable body has an outside surface conforming to the inside surface of the perimeter wall.

33. The process of claim 25 wherein:
the container further includes an opening at the second end region, and
the removal of the friable body from the container includes advancing an ejector axially through the opening at the second end region to axially push the friable body out of the container through the opening at the first region.

34. The process of claim 25 wherein:
the container includes an end wall at the second end region incorporating a flexure; and
the removal of the friable body from the container comprises applying a force to the flexure to move the friable body axially relative to the container, to eject the friable body through the opening.

35. The process of claim 25 further including:
applying an elevated pressure and an elevated temperature to the friable body at the molding station, to selectively reshape the moldable material and to cure the resin.

36. The process of claim 35 wherein:
the elevated pressure is in the range of 1000-4000 psi, and the elevated temperature is in the range of 250-450 degrees F.

37. The process of claim 25 wherein:
said loading a portion of the granular material into the compartment is performed at a preforming station; and
the container, after said removing the friable body from the container, is transferred from the molding station to the preforming station for a subsequent loading of a further metered amount of the granular material into the container.
